(19) United States
(12) Patent Application Publication
(10) Pub. No.: US 2011/0096653 A1
(43) Pub. Date: Apr. 28, 2011

(54) MICRO-HOLOGRAPHIC DATA STORAGE SYSTEM AND METHOD

(75) Inventors: Yosuke MIZUYAMA, Newton, MA (US); Riccardo LETO, Arlington, MA (US)

(73) Assignee: PANASONIC BOSTON LABORATORY, Newton, MA (US)

(21) Appl. No.: 12/770,831

(22) Filed: Apr. 30, 2010

Related U.S. Application Data
(60) Provisional application No. 61/272,727, filed on Oct. 27, 2009.

(51) Int. Cl. G11B 7/00; G11B 7/24

(52) U.S. Cl. 369/103; 369/275.3; G9B/7

(57) ABSTRACT

A micro-holographic data storage system and method. Micro-holograms are written to a data storage medium with two counter-propagating beams via objective recording lenses which have a first numerical aperture (NA) to make the micro-holograms larger. Alternatively, elongated micro-holograms can be produced using counter-propagating beams with different focus points. The micro-holograms are retrieved from the data storage medium using a single beam via an objective reading lens which has a second NA that is higher than the first NA. The data storage medium has a substrate with a plurality of tracks separated by a track pitch. The plurality of micro-holograms are each contained in each of the plurality of tracks, wherein, at least one of the plurality of micro-holograms has a width which is nearly equal to a width of the track pitch.

### BACKGROUND OF THE INVENTION

1. Field of the Invention

The present disclosure relates to a micro-holographic data storage system and a method for storing data on a micro-holographic storage medium.

2. Background and Related Information

In conventional holographic data storage systems, data is stored in volume holograms resulting from the interference of a signal and reference beam. This is known as a so called “volume holographic type data storage system”. However, the volume holographic type data storage system requires the use of specialized components, such as spatial light modulators and charge coupled detectors. This type of system also requires very stringent mechanical tolerances to ensure satisfactory operation.

On the other hand, there is another type of holographic data storage system, known as a so called “micro-holographic data storage system”. This type of system has much more relaxed tolerances and therefore is easier to manufacture and handle. Also, the technology behind the micro-holographic data storage system is compatible with conventional BD/DVD/CD optical drive systems. Thus, the micro-holographic data storage system does not require the development of a completely different optical drive system for its use, unlike the volume holographic type data storage system. This minimizes development time and cost, and reduces production costs. However, there has been an issue with respect to a signal to noise ratio (S/N ratio) of a micro-holographic data storage system. A diffraction efficiency (DE) from a micro-hologram with a high numerical aperture (NA) read beam is thought to be very low, and it has been a concern that the S/N ratio would thus be very low.

### SUMMARY

Therefore, it is an objective of the present disclosure to improve the S/N ratio of a micro-holographic data storage system. The present disclosure provides a micro holographic data storage system in which micro-holograms (data bits) are written with a relatively low NA lens that over-sizes the track pitch to overlap an adjacent hologram, while the signal is read with a relatively high NA lens. The written micro-holograms have wider and longer fringes (in comparison with the micro-holograms of a conventional system) that just fill up the recording pit space, thus maximizing the diffraction efficiency (DE) with the reading beam with the same size as the recording pit space.

According to an object of the present disclosure, a data storage medium comprises a substrate that has a plurality of tracks separated by a track pitch. A plurality of micro-holograms are contained in each of the plurality of tracks. At least one of the plurality of micro-holograms has a width which is nearly equal to a width of the track pitch, which may be approximately equal to 0.32 μm.

According to another object of the present disclosure, a method of storing and retrieving data is disclosed. Micro-holograms are written (recorded) using two counter-propagating beams via objective recording lenses which have a first numerical aperture (NA) to make the micro-holograms larger. The micro-holograms are retrieved (played back) using a single beam via an objective reading lens which has a second NA that is higher than the first NA. According to an advantage of the disclosure, the first NA is equal to approximately 0.6 and the second NA is equal to approximately 0.8. Alternatively, the first NA may be equal to approximately 0.75 and the second NA may be equal to approximately 0.85.

In accordance with another method of storing and retrieving data, micro-holograms are written with two counter-propagating beams via objective lenses which focus at different focus points to make the micro-holograms larger. The micro-holograms are later retrieved using a single beam via an objective lens. According to a feature of the disclosure, the distance of the different focus points is selected to be between approximately 1 μM and 1.5 μm.

According to an object of the disclosure, a method is disclosed for storing and retrieving data, in which micro-holograms are written using two counter-propagating beams via objective lenses that have a first NA and different focus points, so as to make the micro-holograms larger. The micro-holograms are retrieved (played back) using a single beam via an objective lens which has a second NA that is higher than the first NA.

The present disclosure may also be used with a pre-formatted holographic medium (disc). In particular, micro-holograms in the pre-formatted micro-hologram medium are erased using a single beam via an objective lens which has a first NA to effectively form (write) datum in a micro-hologram array. The datum is retrieved from the micro-hologram array using a single beam via an objective lens which has a second NA than is higher than the first NA.

According to an object of the present disclosure, a method of retrieving data from a holographic storage medium is disclosed. Micro-holograms have previously been written to the holographic storage medium using an objective recording lens having a numerical aperture (NA) that is selected to increase a width of at least one micro-hologram to be approximately equal to a track pitch of the holographic storage medium. The micro-holograms are retrieved (read/played back) from the holographic storage medium using an objective reading lens which has a NA that is higher than the NA of the objective recording lens.

Another object of the present disclosure pertains to storing data onto a holographic storage medium. Micro-holograms are written to the holographic storage medium using an objective lens that has a numerical aperture selected to increase a width of at least one micro-hologram, so that the width of the at least one micro-hologram is approximately equal to a track pitch of the holographic storage medium.

### BRIEF DESCRIPTION OF THE DRAWINGS

These and other objects, advantages and features of the present disclosure will become apparent from the following description thereof taken in conjunction with the accompanying drawings that illustrate specific embodiments of the present disclosure, in which:

FIG. 1 illustrates a schematic side view of typical micro-holographic data storage system;

FIG. 2 graphically illustrates a diffraction efficiency (DE) of a reading and writing operation with a same numerical aperture (NA) lens;

FIG. 3 graphically illustrates the DE of a reading and writing operation that employs lenses with different numerical apertures;

FIG. 4 illustrates a schematic side view of micro-holographic data storage system of a first embodiment;

FIG. 5 illustrates a schematic side view of a micro-holographic data storage system of a second embodiment;

FIG. 6 illustrates elongated micro-holograms written by counter-propagating beams having different focus positions;

FIG. 7 illustrates a graph of a micro-hologram height made by two counter-propagating beams at different focus points;

FIG. 8 illustrates a graph of a micro-hologram width made by two counter-propagating beams at different focus points;

FIG. 9 illustrates a DE graph of a micro-hologram made by two counter-propagating beams at different focus points;

FIG. 10 illustrates a schematic side view of a micro-holographic data storage system of a third embodiment; and

FIG. 11 illustrates a schematic side view of a micro-holographic data storage system of a fourth embodiment.

### DETAILED DESCRIPTION OF PREFERRED EMBODIMENTS

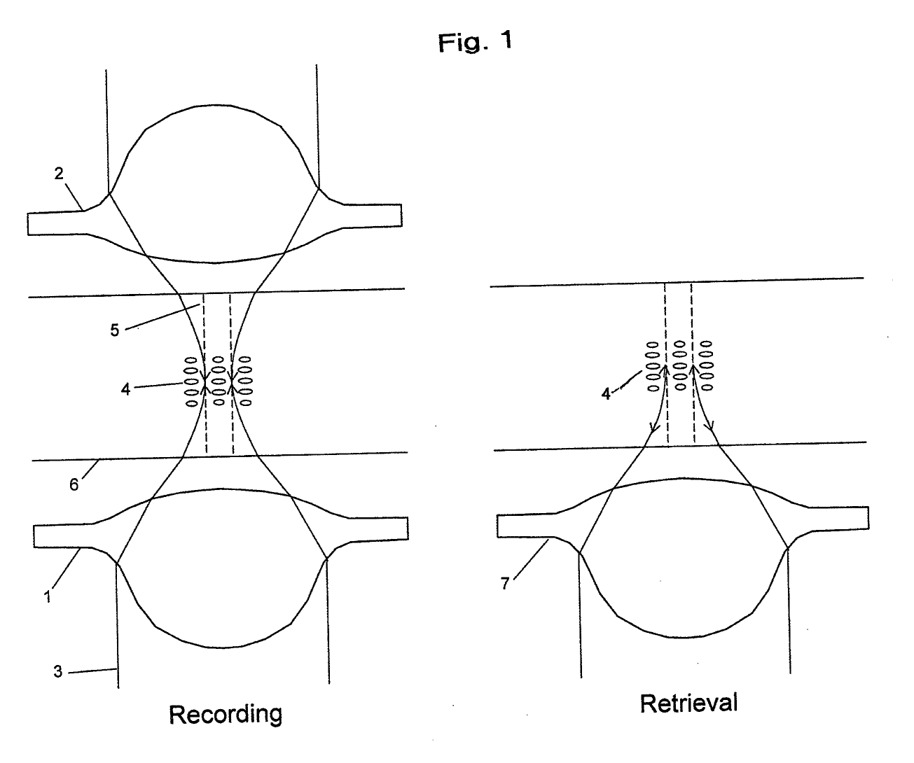

Principles of recording and retrieval methods of a micro-holographic data storage system will now be explained with reference to FIG. 1, which is a schematic side view of a micro-holographic data storage system.

During a recording process, light from a light source, such as, but not limited to, a coherent laser beam, is split into two beams; one beam of which is, via an object beam 3, focused by objective lens 1 into a holographic material 6 of a holographic data storage medium, and a second beam which serves as a reference beam that is focused by objective lens 2 into the holographic material 6.

During a retrieval (playback) operation, the object beam is turned OFF. Thus, only the reference beam is illuminated, via an objective lens 7, into the holographic material 6 to produce a reconstructed beam as a result of diffraction by micro-hologram 4, so that information embedded into the micro-hologram 4 is retrieved.

As shown in FIG. 1, objective lens 1, objective lens 2, and objective lens 7 are basically the same, and the lens NA is determined by a track pitch 5, which may be a pitch size similar to a Blu-ray Disc (BD) system's track of approximately 0.32 μm. However, when the NA and the track pitch match, the size of the actual micro-holograms tend to become smaller than the track pitch. It has been found that the diffraction efficiency (DE) of a micro-hologram is proportional to the hologram size.

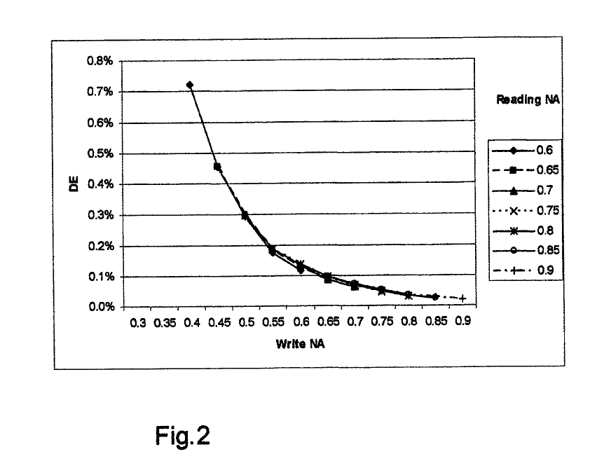

FIG. 2 is a graph showing the DE of a micro-hologram written by two beams in which lenses have the same NA. In this graph, the NA of a recording (writing) objective lens and the NA of a reading (playback) are the same. This graph shows that changes in the NA of both the writing and reading lenses affect the value of the DE. For example, when the NA of a lens is 0.9, the DE is approximately between 0.02% and 0.2%, and when the NA of a lens is 0.6, the DE is roughly between 0.11% and 0.72%. It is thus recognized that the DE is highly dependent on the writing NA of the lens and hence, on the size of the micro-hologram.

The reading and writing operations are separate operations to be performed, and may be performed by different systems, or a common system. When a common system is employed, the optical setup will be similar for the writing and reading operations. However, when two different equipments are employed (for example, a reader that reads the micro-hologram, and a writer that writes the micro-hologram) the optical setups may not necessarily be similar. As described above, micro-holograms must be written using a two counter-propagating beam optical setup while reading can be achieved using only one beam.

It is a reasonable to say that there is a relationship between the DE and the micro-hologram size. One way to improve the DE is to make bigger micro-holograms. The most important dimensions from this point of view is the micro-hologram height and width. Each fringe of the micro-holograms can be thought of as a grating layer. The DE of a grating is higher when the number of fringes is larger; that is, the height of a micro-hologram is larger. Similarly, the DE becomes a higher value when the coverage of the beam with respect to the fringe area of a grating is higher; that is, the width of a micro-hologram is larger.

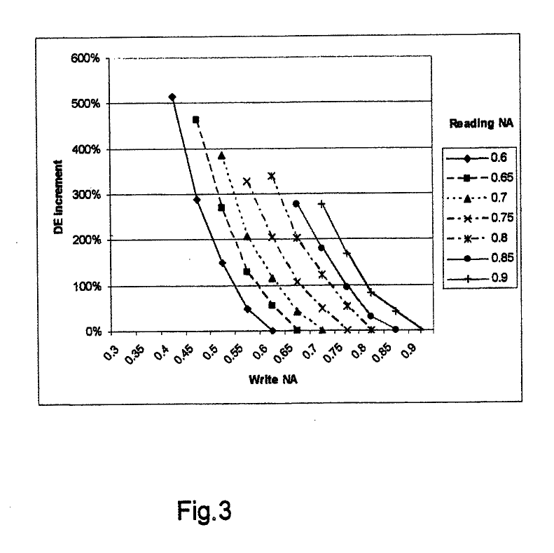

FIG. 3 illustrates a DE graph using reading and writing lenses having different numerical apertures. In this graph, a normalized ΔDE is the normalized change in the DE due to the use of a different writing NA lens. According to this graph, an increase of more than 3 times in the DE is possible when using a NA lens equal to 0.6 for the writing operation and a NA lens equal to 0.8 for the reading operation. FIG. 3 illustrates that there is an increase of around 100% in the DE when using a NA lens equal to 0.75 for the writing operation and a NA lens equal to 0.85 for the reading operation.

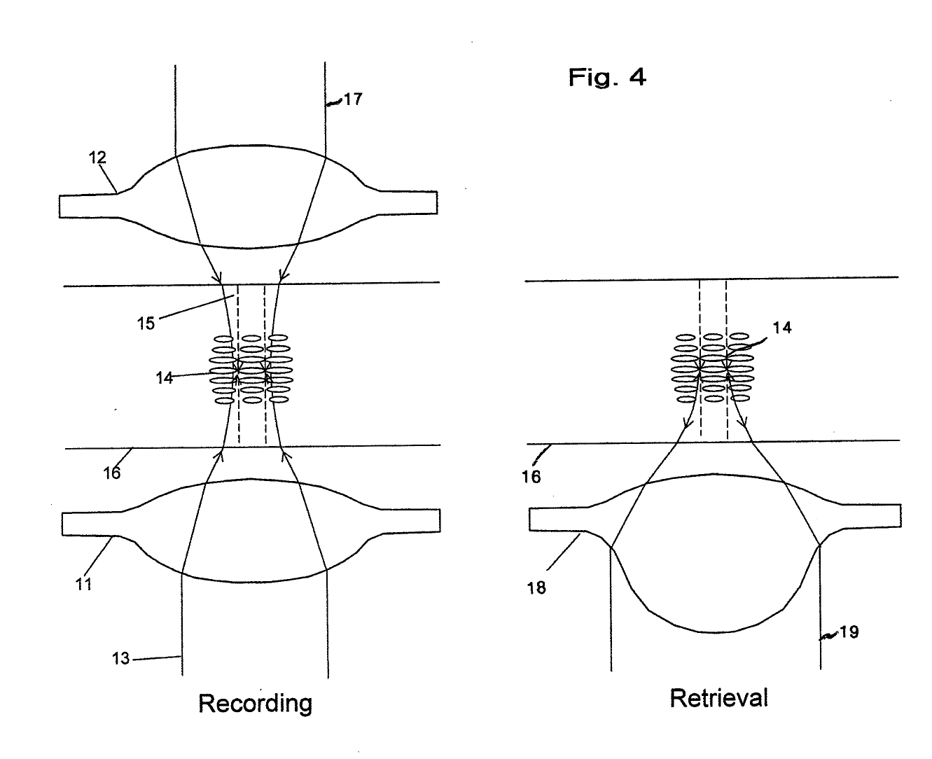

FIG. 4 is a schematic side view of a micro-holographic data storage system of a first embodiment. This embodiment uses different NA lenses between a recording of a disc (such as, for example, a master disc) and a reading of the recorded disc, unlike the system described in FIG. 1, where lenses having the same NA are used for both the recording and reading operations. A lower NA objective lens is used for objective recording lens 11 and objective recording lens 12, while a higher NA lens is used for objective reading lens 18.

In the recording operation, a light such, such as, but not limited to, a coherent laser beam, is spilt into two beams. One beam is referred to as an object beam 17, and is focused by objective recording lens 12 into holographic material 16. A second beam functions as a reference beam 13 and is focused by objective recording lens 11 into the holographic material 16. Micro-holograms 14 are recorded by the objective beam 17 and the reference beam 13 via the objective recording lens 12 and the objective recording lens 11, which has a lower NA. In this situation, the micro-holograms 14 become larger than the micro-holograms 4 described in FIG. 1, becoming equivalent in size to a track pitch 15. These larger micro-holograms optimize the DE when they are read. According to a variation of this embodiment, the objective recording lens 12, which emanates a counter-propagating light, may be replaced by, for example, a retro-reflector or a plain mirror without departing from the scope and/or spirit of the present disclosure.

When retrieving (playing back) the data recorded into the holographic material 16, the object beam is turned OFF. Thus, only reference beam 19 is illuminated via objective reading lens 18. Objective reading lens 18 has a NA that is higher that the NA of the objective recording lens 11 and the objective recording lens 12, and produces a reconstructed beam as a result of diffraction by the micro-holograms 14, so that the embedded information of the micro-holograms 14 is retrieved.

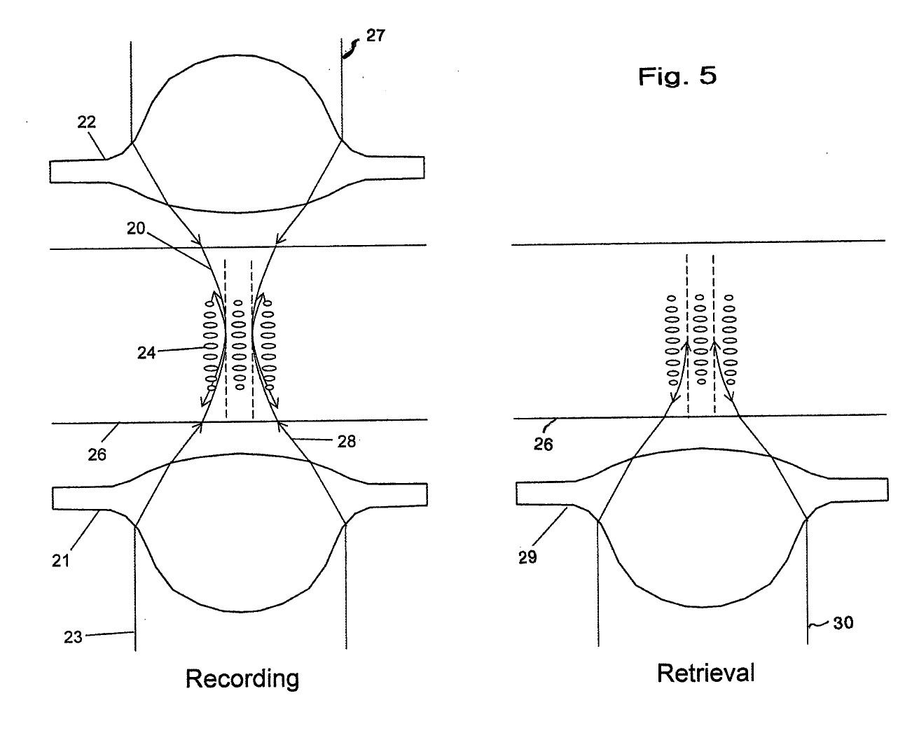

FIG. 5 is a schematic side view of a micro-holographic data storage system according to a second embodiment. In the second embodiment, a light source, such as, for example, a coherent laser beam, is split into two beams during a recording (writing) operation; namely, the coherent laser (light) beam is split into an object beam 27 that is focused by objective recording lens 22 into a holographic material 26, and a reference beam 23 that is focused by objective recording lens 21 into the holographic material 26. Micro-holograms 24 are recorded by the object beam 27 and the reference beam 23 via the objective recording lens 22 and the objective recording lens 21. In this embodiment, the objective recording lens 22 is shifted to have a focus spot of the object beam 27 shifted from a focus spot of the reference beam 23. Therefore, a focusing beam 28 from the objective recording lens 21 and a focusing beam 20 from the objective recording lens 22 overlap at different focus points. This results in the micro-hologram 24 becoming longer, which results in an improved DE.

During the retrieval (playback) operation, the object beam 27 is turned OFF. Thus, only reference beam 30 illuminates the holographic material 26, via objective reading lens 29, to produce a reconstructed beam as a result of diffraction by the micro-holograms 24, so that the embedded information of the micro-holograms 24 is retrieved.

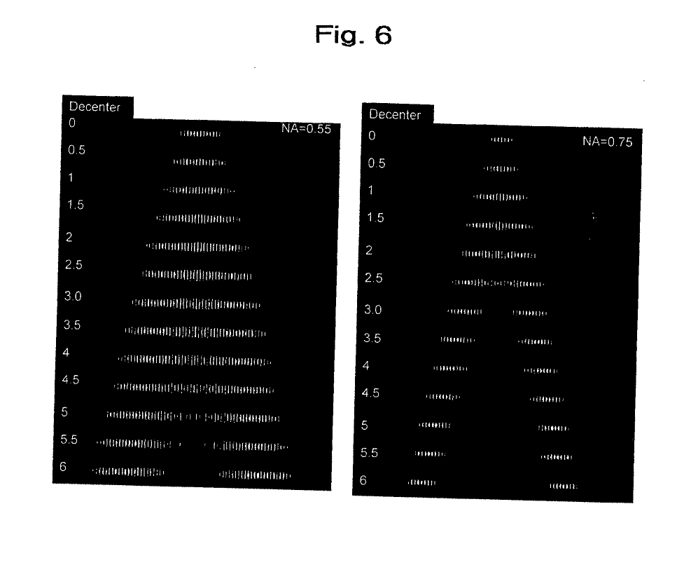

FIG. 6 shows elongated micro-holograms written by counter-propagating beams having different focus positions. Each plot of the drawing depicts a light intensity of interference fringes in the micro-holograms 24 that are binarized at a certain threshold value (i.e., a different threshold is used for each row for display purposes). As the distance of the different focus point increases, the interference fringes are elongated and the DE becomes larger. However, once the distance exceeds a predetermined amount, the interference fringes separate from each other, and the DE decreases. For example, in a case where the NA is equal to 0.75, when the distance of the different focus point is larger than 2.5 μm, the fringes are split into two at the specific binarizing threshold. Similarly, for example, when the NA is equal to 0.55, where, the distance of the different focus point is larger than 5.0 μm the fringes separate into two at the specific binarizing threshold. Accordingly, in this embodiment, there is a peak range of the difference of the focus point that maximizes the DE.

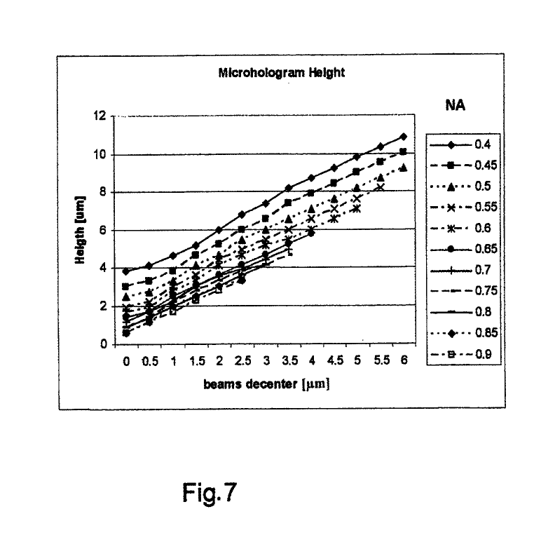

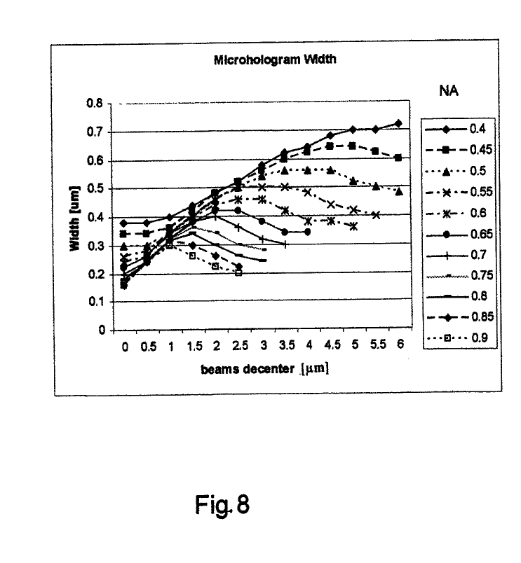

FIGS. 7 and 8 represent computer simulation results of the width and height of a micro-hologram created by two counter-propagating beams that focus at different points. The horizontal axis represents a distance between two foci. FIG. 7 shows that a height monotonically increases, while FIG. 8 shows that a width is maximized, as the focus separation increases.

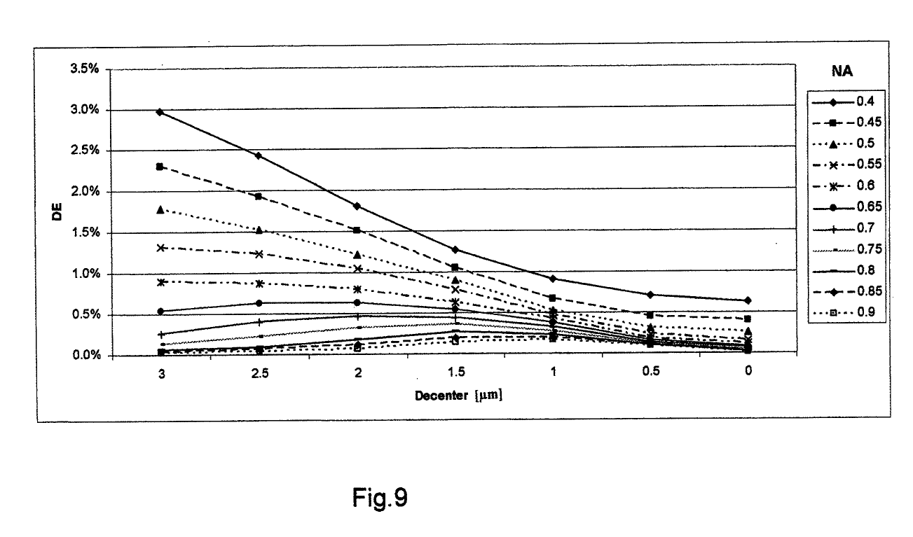

FIG. 9 is a graph of the DE with varied focus separations. The graph shows that different focus points can greatly improve the DE. In the case where, for example, the NA is equal to 0.4, the DE is around 1.2% when the focus separation is 1.5 μm and only 0.6% when there is no focus separation, which means there is an increase of 100% in the DE.

The DE from elongated micro-holograms is depicted in FIG. 9. The trend in FIG. 9 essentially has an optimal point where the DE becomes a maximum. For example, a graph of a lens having a NA equal to 0.9 has a peak when the focus separation is around 1.5 μm. In another example, a peak for a lens having a NA equal to 0.65 occurs when the focus separation is around 2.0 μm. For lenses having a lower NA (e.g. a lens having a NA equal to approximately 0.4 to 0.6), the peaks are not shown, but exist at a longer separation range. An appropriate focus separation can thus be chosen by finding the peak on the graph, NA values, and so on.

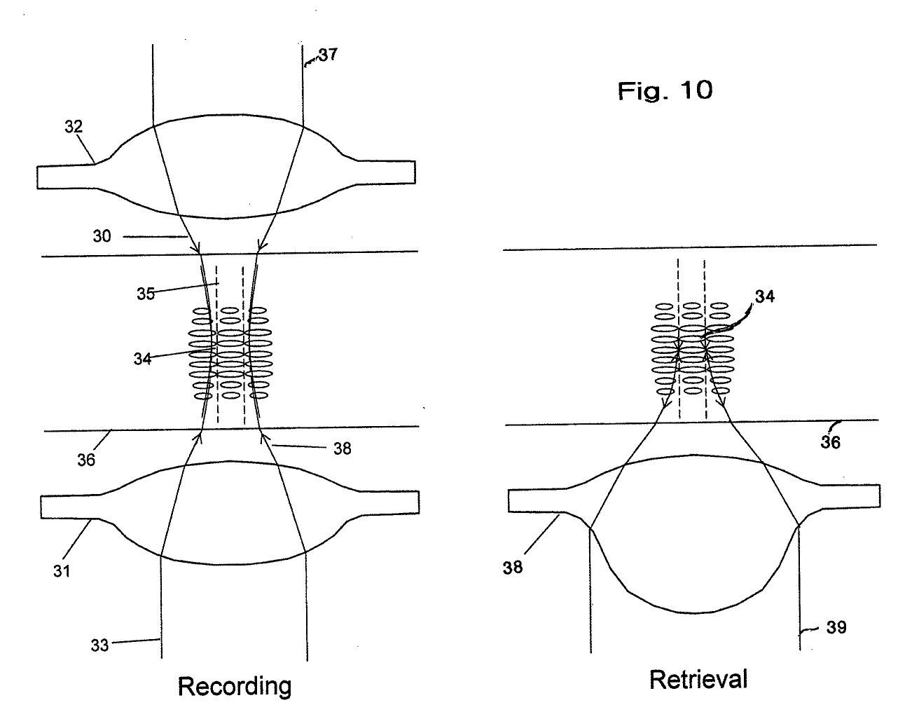

FIG. 10 is a schematic side view of a micro-holographic data storage system of a third embodiment. The third embodiment is a combination of the first embodiment and the second embodiment.

During a recording operation, a light beam (such as, for example, a coherent laser beam) is split into two beams; namely, an object beam 37 and a reference beam 33. The object beam 37 is focused by a recording objective lens 32 into holographic material 36. The reference beam 33 is focused by recording objective lens 31 into the holographic material 36. Micro holograms 34 are recorded by the objective beam 37 and the reference beam 33 via the recording objective lens 32 and the recording objective lens 31. Further, the recording objective lens 32 is shifted to result in a focus spot that is shifted from an other focus spot made by the recording objective lens 31. In this embodiment, the recording objective lens 32 and the recording objective lens 31 are selected to have a NA that is lower than a NA of a reading objective lens 38. Therefore, the focusing beam 39 from the recording objective leans 31 and the focusing beam 30 from the recording objective lens 32 overlap at different focus points, resulting in the micro-hologram 24 becoming longer and larger, which results in an improved DE.

During a retrieval (playback) operation, the objective beam 37 is turned OFF. As a result, only a reference beam 39 illuminates the holographic material 36 via reading objective lens 38 (which, as noted above, has a NA that is higher than the NA of the recording objective lens 31 and the recording objective lens 32), so as to produce a reconstructed beam as a result of diffraction by the micro-holograms 34, so that the embedded information of the micro-holograms 34 is retrieved.

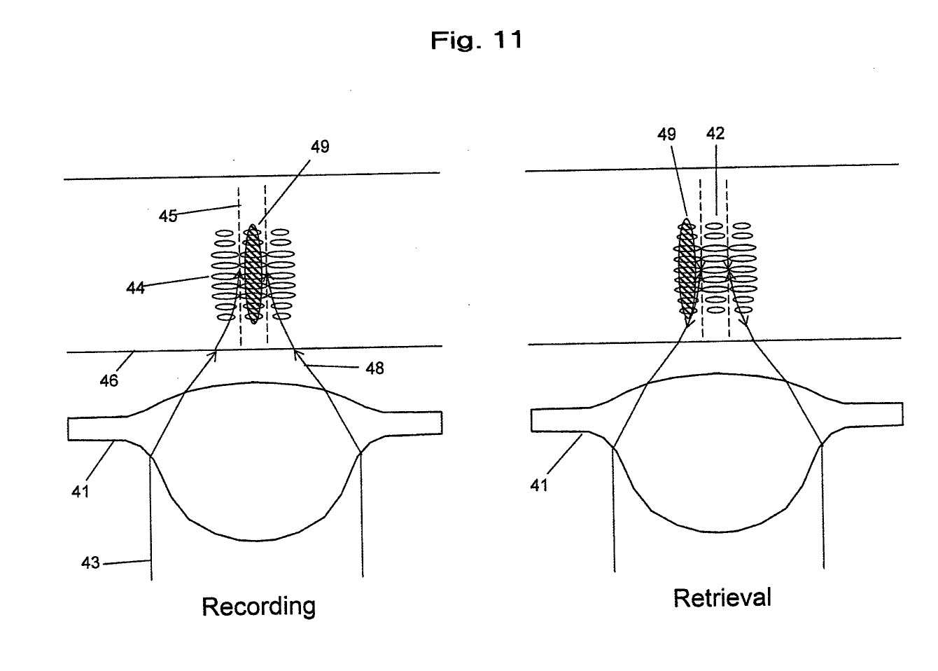

A schematic side view of a micro-holographic data storage system according to a fourth embodiment is illustrated in FIG. 11. The fourth embodiment is a based upon an erasing method, such as described in, for example, U.S. Pat. No. 7,388,695, that is used with a pre-formatted holographic storage medium (disc).

In the micro-holographic data storage system of the fourth embodiment, a pre-formatted holographic disc 46 is filled with arrays of micro-holograms 44 beforehand. The arrays of micro-holograms 44 are spread throughout substantially all of the volume of the pre-formatted holographic disc 46, which is made of an optically non-linear or threshold responsive recording material. In this embodiment, datum is recorded in the pre-formatted holographic disc 46 by erasing (or not erasing) predetermined ones of the micro-holograms 44. Erasing may be done, for example, using a coherent laser beam 43 that has sufficient focused energy to bring a volume of the micro-holograms 44 above a threshold condition. For example, the coherent laser beam 43 provides enough heating to approach a predetermined temperature Tg that causes a constituent polymer matrix of a material forming the micro-hologram to change its structure.

During a recording operation, the coherent laser beam 43 is focused by an objective lens 41 into the pre-formatted holographic disc 46.

The datum is recorded by exposing the micro-holograms 44 to eliminate the fringes, so that the micro-holograms 44 become a simple solid ellipsoid with no refractive index modulation.

The micro-holograms 44 in the pre-formatted disc 46 are made using an objective lens in a recording system (not shown) or a pre-formatter (not shown) that has a NA that is lower than the NA of a lens used by the micro-holographic data storage system of the fourth embodiment. A single objective lens system can record a bit datum using objective lens 41 by exposing a first micro-hologram 49 at a specific position. The first micro-hologram 49 then becomes a “zero-bit” to represent “nothing”.

During a retrieval (playback) operation, the objective lens 41 irradiates a second micro-hologram 42 which is not erased and is next to the first micro-hologram 49, to obtain diffracted light as the datum.

The foregoing discussion has been provided merely for the purpose of explanation and is in no way to be construed as limiting the present disclosure. While the present disclosure has been described with reference to exemplary embodiments, it is understood that the words which have been used herein are words of description and illustration, rather than words of limitation. Changes may be made, within the purview of the appended claims, as presently stated and as amended, without departing from the scope and/or spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The methods described herein comprise dedicated hardware implementations. However, it is understood that alternative implementations can be constructed to implement the methods described herein. In addition, although the present specification may describe components and functions implemented in the embodiments with reference to particular standards and protocols, the disclosure is not limited to such standards and protocols. Such standards are periodically superseded by equivalents having essentially the same functions. Replacement standards and protocols having the same functions are considered equivalents.

We claim:

1. A data storage medium, comprising:
a substrate having a plurality of tracks separated by a track pitch; and
a plurality of micro-holograms contained in each of said plurality of tracks, wherein, at least one of said plurality of micro-holograms has a width which is approximately equal to a width of said track pitch.

2. The data storage medium of claim 1, wherein said track pitch is approximately equal to 0.32 μm.

3. A method of storing and retrieving data, comprising:
writing micro-holograms with two counter-propagating beams via objective recording lenses which have a first numerical aperture (NA) to make the micro-holograms larger; and
retrieving the micro-holograms with a single beam via an objective reading lens which has a second NA that is higher than the first NA.

4. The method of storing and retrieving data of claim 3, wherein the first NA is equal to approximately 0.6 and the second NA is equal to approximately 0.8.

5. The method of storing and retrieving data of claim 3, wherein the first NA is equal to approximately 0.75 and the second NA is equal to approximately 0.85.

6. A method of storing and retrieving data, comprising:
writing micro-holograms with two counter-propagating beams via objective lenses which focus at different focus points to make the micro-holograms larger; and
retrieving the micro-holograms with a single beam via an objective lens.

7. The method for storing and retrieving data of claim 6, wherein a distance of the different focus points is between approximately 1 μm and 1.5 μm.

8. A method for storing and retrieving data, comprising:
writing micro-holograms with two counter-propagating beams via objective lenses which have a first NA and different focus points to make the micro-holograms larger; and
retrieving micro-holograms with a single beam via an objective lens which has a second NA that is higher than the first NA.

9. A method for storing and retrieving data, comprising:
erasing micro-holograms in a pre-formatted micro-hologram medium using a single beam via an objective lens which has a first NA to form datum in a micro-hologram array; and
retrieving the datum from the micro-hologram array with single beam via an objective lens which has a second NA than is higher than the first NA.

10. A method of retrieving data from a holographic storage medium, in which micro-holograms have been written to the holographic storage medium using an objective recording lens having a numerical aperture (NA) selected to increase a width of at least one micro-hologram to be approximately equal to a track pitch of the holographic storage medium, comprising:
retrieving the micro-holograms from the holographic storage medium using an objective reading lens which has a NA that is higher than the NA of the objective recording lens.

11. A method for storing data onto a holographic storage medium, comprising:
writing micro-holograms to the holographic storage medium using an objective lens that has a numerical aperture selected to increase a width of at least one micro-hologram to be approximately equal to a track pitch of the holographic storage medium.
